(19) United States
(12) Patent Application Publication
(10) Pub. No.: US 2023/0169411 A1
(43) Pub. Date: Jun. 1, 2023

(54) INFORMATION PROCESSING DEVICE, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventor: Ai MIYATA, Osaka (JP)

(21) Appl. No.: 18/047,317

(22) Filed: Oct. 18, 2022

(30) Foreign Application Priority Data
Nov. 29, 2021 (JP) 2021-193649
Nov. 29, 2021 (JP) 2021193649

(51) Int. Cl. G06Q 10/02; G06Q 30/02; G06Q 30/06

(52) U.S. Cl. CPC G06Q 10/02; G06Q 30/0207; G06Q 30/0645

(57) ABSTRACT

An information processing device includes a communication unit and a control unit. The control unit receives, with the communication unit, a desired condition desired by a user regarding a usage reservation of car sharing, in addition to the usage reservation of car sharing. The control unit generates a usage condition of another user of car sharing to satisfy the desired condition when the control unit determines that the desired condition of the user is not satisfied based on a status of the usage reservation of car sharing before a desired start date and time at which the user desires to start using a vehicle. The control unit determines that an incentive is given to the other user when the other user makes a usage reservation of car sharing so as to satisfy the usage condition.

### CROSS-REFERENCE TO RELATED APPLICATION

This application claims priority to Japanese Patent Application No. 2021-193649 filed on Nov. 29, 2021, incorporated herein by reference in its entirety.

### BACKGROUND

### 1. Technical Field

The present disclosure relates to an information processing device, an information processing system, and an information processing method.

### 2. Description of Related Art

Conventionally, a system for making a usage reservation of car sharing has been known. For example, Japanese Unexamined Patent Application Publication No. 2021-86170 (JP 2021-86170 A) describes a management server having a database for accumulating data regarding a usage reservation for sharing vehicles.

### SUMMARY

Depending on a status of a usage reservation for vehicles, parking spaces, and the like, a usage reservation of car sharing may not be established.

An object of the present disclosure made in view of such a point is to provide a technique for facilitating the establishment of a usage reservation of car sharing.

An information processing device according to one embodiment of the present disclosure includes: a communication unit; and a control unit that receives, with the communication unit, a desired condition desired by a user regarding a usage reservation of car sharing, in addition to the usage reservation of car sharing, in which the control unit generates a usage condition of another user of car sharing to satisfy the desired condition when the control unit determines that the desired condition of the user is not satisfied based on a status of the usage reservation of car sharing before a desired start date and time at which the user desires to start using a vehicle, and determines that an incentive is given to the other user when the other user makes a usage reservation of car sharing so as to satisfy the usage condition.

An information processing system according to an embodiment of the present disclosure includes: the information processing device; and a terminal device of the user.

An information processing method according to the one embodiment of the present disclosure includes: receiving, with a communication unit, a desired condition desired by a user regarding a usage reservation of car sharing, in addition to the usage reservation of car sharing; generating a usage condition of another user of car sharing to satisfy the desired condition when determining that the desired condition of the user is not satisfied, based on a status of the usage reservation of car sharing, before a desired start date and time at which the user desires to start using a vehicle; and determining that an incentive is given to the other user when the other user makes a usage reservation of car sharing so as to satisfy the usage condition.

According to an embodiment of the present embodiment, it is possible to provide a technique that facilitates the establishment of a usage reservation of car sharing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system according to an embodiment of the present disclosure;

FIG. 2 is a block diagram showing the information processing system shown in FIG. 1;

FIG. 3 is a diagram illustrating a timing for executing a determination process;

FIG. 4 is a diagram showing an example of a reservation screen;

FIG. 5 is a diagram showing an example of the reservation screen; and

FIG. 6 is a flowchart showing an operation of an information processing device shown in FIG. 2.

### DETAILED DESCRIPTION OF EMBODIMENTS

Hereinafter, an embodiment of the present disclosure will be described below with reference to the drawings.

System Configuration

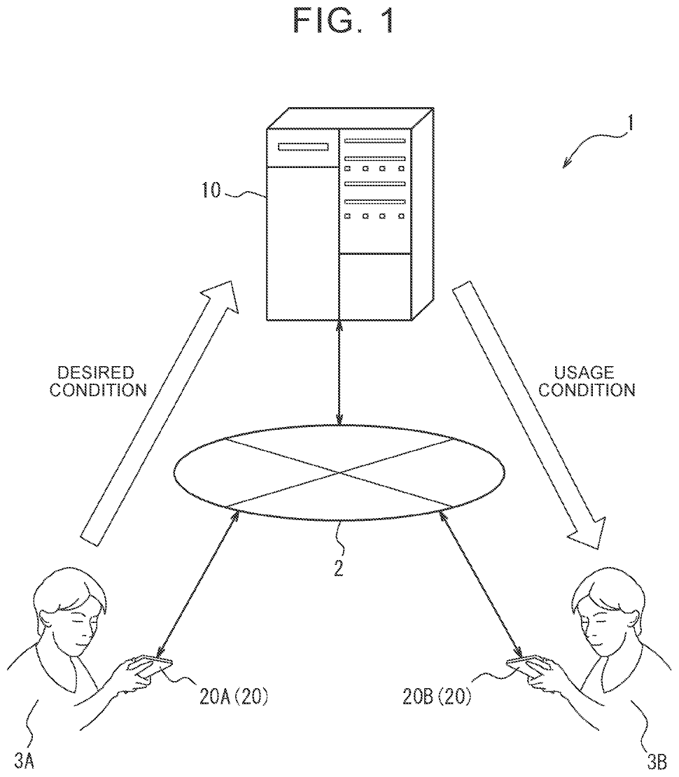

As shown in FIG. 1, the information processing system 1 includes at least one information processing device 10, at least one terminal device 20A, and at least one terminal device 20B.

Hereinafter, when the terminal device 20A and the terminal device 20B are not particularly distinguished, these are collectively referred to as a “terminal device 20”.

The information processing device 10 and the terminal device 20 can communicate with each other via a network 2. The network 2 may be any network including a mobile communication network, the Internet, and the like.

The information processing device 10 can provide a platform for a car sharing service. The car sharing service is a service for renting a vehicle to a pre-registered member. The pre-registered members are, for example, user 3A and user 3B.

The car sharing service according to the present embodiment is a one-way type service. However, the car sharing service is not limited to the one-way type service, as described later. The one-way type car sharing service is a service that allows a user to have a rental station for renting a vehicle and a return station for returning the vehicle, in which the rental stations are different from each other. The station is, for example, a parking lot where unused vehicles are waiting. The rental station is also described as a “departure point”. The return station is also described as a “destination”.

The information processing device 10 manages a usage reservation of car sharing. The usage reservation of car sharing according to the present embodiment includes a usage reservation of a rental station, that is, a vehicle scheduled to be rented at a departure point, and a usage reservation of a parking space for returning a vehicle at a return station, that is, a destination.

The information processing device 10 can accept a desired condition desired by the user regarding the usage reservation of car sharing, in addition to the usage reservation of car sharing. Accepting the user's desired condition is also referred to as “pre-booking”. Details of the desired condition will be described later. In the present embodiment, the information processing device 10 receives the desired condition of the user 3A.

When the information processing device 10 determines that the desired condition of the user 3A is not satisfied based on the status of the usage reservation of car sharing, the information processing device 10 generates the usage condition of another user of car sharing to satisfy the desired condition of the user 3A. When another user makes a usage reservation of car sharing so as to satisfy this usage condition, the user's desired condition can be satisfied. When the other user makes a usage reservation of car sharing so as to satisfy the usage condition, the information processing device 10 determines that an incentive is given to the other user. By giving an incentive, it is possible to motivate the other user to make the usage reservation of car sharing so as to satisfy the usage condition. With such a configuration, since the possibility that the desired condition of the user 3A is satisfied is increased, the usage reservation of car sharing is easily established.

The information processing device 10 may be operated by an entity that provides a car sharing service. The information processing device 10 is a dedicated computer configured to function as a server, a general-purpose personal computer, a cloud computing system, or the like.

The terminal device 20A can be used by the user 3A. The user 3A uses the terminal device 20A and transmits the desired condition of the user 3A from the terminal device 20A to the information processing device 10.

The terminal device 20B is used by the user 3B. The user 3B is a user who is considering making a usage reservation of car sharing. The user 3B can use the terminal device 20B and see the usage condition generated by the information processing device 10. The user 3B looks at the usage condition generated by the information processing device 10, and considers whether to make a usage reservation of car sharing based on the usage condition.

A reservation application may be downloaded to the terminal device 20. The reservation application is a dedicated application for making a usage reservation of car sharing.

The terminal device 20 may be any device as long as it can be connected to the network 2. The terminal device 20 is, for example, a mobile phone, a smartphone, a tablet, a personal computer (PC), or the like.

Configuration of Information Processing Device

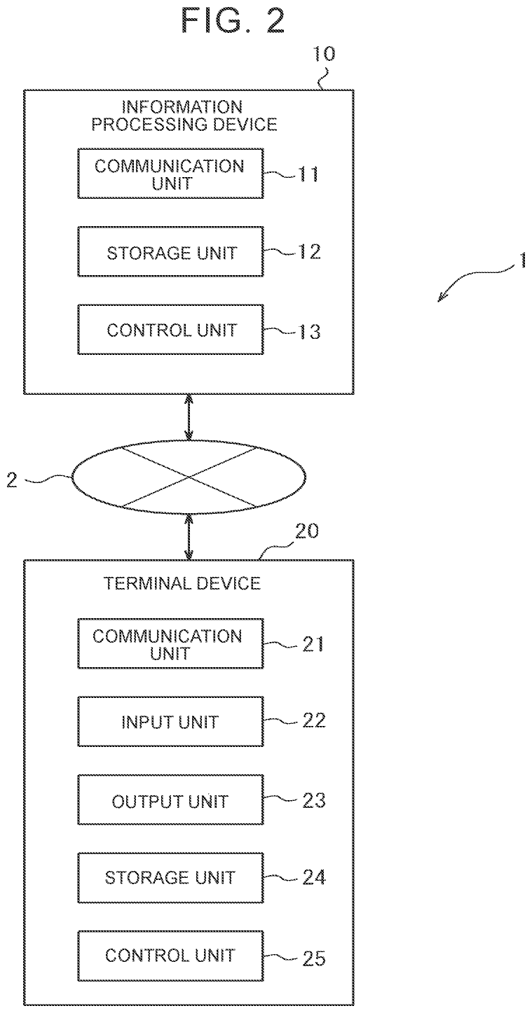

As shown in FIG. 2, the information processing device 10 includes a communication unit 11, a storage unit 12, and a control unit 13.

The communication unit 11 includes at least one communication module that can be connected to the network 2. The communication module is, for example, a communication module corresponding to a standard such as a wired local area network (LAN) or a wireless LAN. However, the communication module is not limited to this. The communication module may correspond to any communication standard. The communication unit 11 is connected to the network 2 with the communication module via a wired LAN or a wireless LAN.

The storage unit 12 is configured to include at least one semiconductor memory, at least one magnetic memory, at least one optical memory, or a combination of at least two of them. The semiconductor memory is, for example, a random access memory (RAM), a read-only memory (ROM), or the like. The RAM is, for example, a static random access memory (SRAM), a dynamic random access memory (DRAM), or the like. The ROM is, for example, an electrically erasable programmable read only memory (EEPROM). The storage unit 12 may function as a main storage device, an auxiliary storage device, or a cache memory. The storage unit 12 stores data used for the operation of the information processing device 10 and data acquired through the operation of the information processing device 10.

The control unit 13 includes at least one processor, at least one dedicated circuit, or a combination thereof. The processor is, for example, a general-purpose processor such as a central processing unit (CPU) or a graphics processing unit (GPU), or a dedicated processor specialized for a specific process. The dedicated circuit is, for example, a field-programmable gate array (FPGA) or an application-specific integrated circuit (ASIC). The control unit 13 performs processes related to the operation of the information processing device 10 while controlling various units of the information processing device 10.

The function of the information processing device 10 can be realized by executing a processing program according to the present embodiment with the processor corresponding to the control unit 13. That is, the function of the information processing device 10 can be realized by software. The processing program causes the computer to function as the information processing device 10 by causing the computer to perform the operations of the information processing device 10. That is, the computer functions as the information processing device 10 by performing the operations of the information processing device 10 according to the processing program.

In the present disclosure, the “program” can be recorded on a computer-readable non-transitory recording medium. The computer-readable non-transitory recording medium is, for example, a magnetic recording device, an optical disc, an opto-magnetic recording medium, or a ROM. The distribution of the program is carried out, for example, by selling, transferring, or renting a portable recording medium such as a digital versatile disc (DVD) or a compact disc read only memory (CD-ROM) on which the program is recorded. The program may be stored in the storage of the server. The program stored in the storage of the server may be distributed by being transferred to another computer. The program may be provided as a program product.

In the present disclosure, for example, the “computer” temporarily stores a program recorded on a portable recording medium or a program transferred from the server in a main storage device. In addition, the computer causes the processor to read the program stored in the main storage device and causes the processor to perform processes according to the read program. The computer may read the program directly from the portable recording medium and execute processes in accordance with the program. The computer may perform the processes according to the received program each time the program is transferred from the server to the computer. The computer may execute the processes with a so-called application service provider (ASP) type service that realizes the function only by the execution command and the result acquisition without transferring the program from the server to the computer. The program includes information that is used for processing by electronic computers and equivalent to a program. For example, data that is not a direct command to a computer but has the property of defining the process of the computer corresponds to the “data equivalent to a program”.

A part or all of the functions of the information processing device 10 may be realized by a dedicated circuit corresponding to the control unit 13. That is, a part or all of the functions of the information processing device 10 may be realized by hardware.

The control unit 13 receives the desired condition desired by the user regarding the usage reservation of car sharing, in addition to the usage reservation of car sharing. The control unit 13 receives the desired condition of the user 3A by the communication unit 11, from the terminal device 20A via the network 2. The control unit 13 receives the desired condition of the user 3A by receiving the desired condition of the user 3A.

The user's desired condition includes, for example, at least one of a desired start date and time, a desired departure point, a desired end date and time, and a desired destination. The desired start date and time is the date and time when the user desires to start using the vehicle. The desired departure point is the departure point of the vehicle desired by the user. The desired departure point is, for example, a rental station. The desired end date and time is the date and time when the user desires to end the use of the vehicle. The desired destination is the destination of the vehicle desired by the user. The desired destination is, for example, a return station.

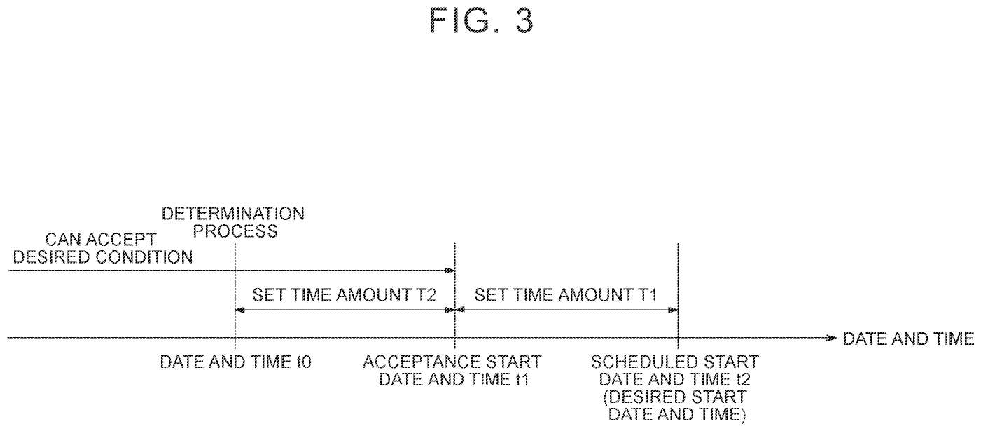

As shown in FIG. 3, the control unit 13 may be able to accept the user's desired condition before an acceptance start date and time t1 for starting the acceptance of the usage reservation of car sharing. The acceptance start date and time t1 is, for example, a date and time before a set time amount T1 than a scheduled start date and time t2 at which the start of usage of the vehicle is scheduled. The desired start date and time of the user may be treated as the scheduled start date and time t2. The set time amount T1 may be appropriately set based on the number of vehicles in the car sharing service, and the like. The set time amount T1 is, for example, 30 minutes.

The control unit 13 determines whether the desired condition of the user 3A is satisfied based on the status of the usage reservation of car sharing before the desired start date and time of the user 3A. The status of the car sharing reservation may include at least one of the status of the vehicle usage reservation at the rental station, which is the desired departure point, and the status of the parking space usage reservation at the return station, which is the desired destination. Hereinafter, the process of determining whether the user's desired condition is satisfied is also described as a “determination process”.

Regarding the timing of executing the determination process, the control unit 13 may execute the determination process, for example, at a date and time t0 that is a set time amount T2 before the acceptance start date and time t1 as shown in FIG. 3. The date and time t0 is a date and time that is the set time amount T2 before the acceptance start date and time t1. The set time amount T2 may be set as appropriate in consideration of the time for another user to consider whether to make a usage reservation by looking at the usage condition. As described above, the desired start date and time of the user may be treated as the scheduled start date and time t2. For example, it is assumed that the set time amount T1 is 30 minutes and the set time amount T2 is 2 hours. In this case, the control unit 13 executes the determination process at the date and time t0 that is 2 hours and 30 minutes before the desired start date and time of the user such as the scheduled start date and time t2.

The date and time when the determination process is executed is not limited to the date and time t0 as shown in FIG. 3. For example, in the configuration shown in FIG. 3, the control unit 13 may accept the desired condition of the user 3A after the date and time t0. In this case, the control unit 13 may execute the determination process by the acceptance start date and time t1 or by the scheduled start date and time t2, depending on the specifications of the car sharing service.

When the control unit 13 determines that the desired condition of the user 3A is satisfied based on the status of the usage reservation of car sharing, the control unit 13 determines that the usage reservation of car sharing is established under the desired condition of the user 3A. The control unit 13 transmits an establishment notification indicating that the usage reservation of car sharing under the desired condition of the user 3A has been established to the terminal device 20A via the network 2 by the communication unit 11.

When the control unit 13 determines that the desired condition of the user 3A is not satisfied based on the status of the usage reservation of car sharing, the control unit 13 generates the usage condition of another user of car sharing to satisfy the desired condition of the user 3A. As described above, when another user makes a usage reservation of car sharing so as to satisfy this usage condition, the desired condition of the user 3A can be satisfied. The usage condition may include an arbitrary condition depending on the desired condition. The usage condition includes, for example, at least one of a usage start date and time when another user starts using the vehicle, a departure point, a usage end date and time when another user ends the usage of the vehicle, and a destination.

As an example, the desired condition of the user 3A is set to include a desired start date and time and a desired departure point. In this case, when the control unit 13 determines that there is no vehicle that can be rented at the station that is the desired departure point at the desired start date and time based on the status of the vehicle usage reservation in car sharing, the control unit 13 determines that the desired condition of the user 3A is not satisfied. The control unit 13 generates, as a usage condition of the other user, a usage condition in which the desired start date and time of the user 3A is set as the usage end date and time and the desired departure point of the user 3A is the destination, that is, the return station. When the other user makes a usage reservation so as to satisfy this usage condition, the other user can end the use of the vehicle at the desired start date and time of the user 3A and return the vehicle to the station of the desired departure point of the user 3A. With such a configuration, a vehicle that can be rented to the station at the desired departure point at the desired start date and time of the user 3A becomes present. Thus, the desired condition of the user 3A is satisfied.

As another example, the desired condition of the user 3A is set to include a desired end date and time and a desired destination. In this case, when the control unit 13 determines that there is no parking space in which the vehicle can be parked at the station that is the desired destination at the desired end date and time based on the status of the vehicle usage reservation in car sharing, the control unit 13 determines that the desired condition of the user 3A is not satisfied. As the usage condition of the other user, the control unit 13 sets the desired end date and time of the user 3A as the usage start date and time, and generates the usage condition in which the desired destination of the user 3A is set as the departure point. When the other user makes a usage reservation so as to satisfy this usage condition, the other user starts using the vehicle at the desired end date and time of the user 3A, and the other user can make the vehicle depart from the parking space of the station of the desired destination of the user 3A. With such a configuration, a parking space in which the vehicle can be parked at the desired destination at the desired end date and time of the user 3A becomes present. Thus, the desired condition of the user 3A is satisfied.

When the control unit 13 generates the usage condition of the other user, the control unit 13 may notify the other user of the generated usage condition as a condition for which an incentive is given. The control unit 13 may notify the other user of the usage condition by any method.

As an example, the control unit 13 may notify the other user of the usage condition by posting the usage condition on a site of the car sharing service. The site of this car sharing service may be accessible by the terminal device 20 via the reservation application. With such a configuration, as shown in FIG. 5 described later, the usage condition can be displayed on the terminal device 20B as the condition for giving the incentive.

As another example, the control unit 13 may transmit a notification such as an e-mail indicating the usage condition to the terminal device 20 of the other user by the communication unit 11. That is, the control unit 13 may notify the other user of the usage condition by transmitting a notification indicating the usage condition to the terminal device 20 of the other user.

When the control unit 13 makes a usage reservation of car sharing so that other user satisfies the usage condition before the acceptance start date and time t1 as shown in FIG. 3, for example, the control unit 13 determines to give an incentive to the other user. For example, the control unit 13 can receive an application notification for applying for a usage reservation of car sharing under the usage condition, by the communication unit 11 from the terminal device 20B via the network 2, before the acceptance start date and time t1. In this case, the control unit 13 determines to give an incentive to the user 3B. The incentive may be given in the form of returning a profit in the car sharing service to the user. The incentive may be a discount on a usage fee of the car sharing service. The incentive may be points applicable to a payment of the usage fee of the car sharing service.

When the other user makes a usage reservation of car sharing so as to satisfy the usage condition, the control unit 13 determines that the usage reservation of car sharing is established under the desired condition of the user 3A. The control unit 13 transmits the establishment notification to the terminal device 20A via the network 2 by the communication unit 11.

When the control unit 13 does not make a vehicle usage reservation so that other user satisfies the usage condition by the acceptance start date and time t1 as shown in FIG. 3, the control unit 13 may determine that the usage reservation of car sharing under the desired condition of the user 3A is not established. In this case, the control unit 13 transmits a non-establishment notification indicating that the usage reservation of car sharing under the desired condition of the user 3A has not been established to the terminal device 20A via the network 2 by the communication unit 11.

Configuration of Terminal Device

As shown in FIG. 2, the terminal device 20 includes a communication unit 21, an input unit 22, an output unit 23, a storage unit 24, and a control unit 25.

The communication unit 21 includes at least one communication module that can be connected to the network 2. The communication module is, for example, a communication module conforming to mobile communication standards such as the long term evolution (LTE), fourth generation (4G), or fifth generation (5G). However, the communication module is not limited to this. The communication module may correspond to any communication standard.

The input unit 22 can accept input from the user. The input unit 22 may include at least one input interface capable of receiving input from the user. The input interface is, for example, a physical key, a capacitive key, a pointing device, a touch screen integrated with a display, or a microphone. However, the input interface is not limited to this.

The output unit 23 can output data. The output unit 23 includes at least one output interface capable of outputting data. The output interface is, for example, a display or a speaker. The display may be, for example, a liquid crystal display (LCD), an organic electroluminescence (EL) display, or the like. However, the output interface is not limited to this.

The storage unit 24 includes at least one semiconductor memory, at least one magnetic memory, at least one optical memory, or a combination of at least two of them. The semiconductor memory is, for example, a RAM, or a ROM. The RAM is, for example, a static random access memory (SRAM) or a dynamic random access memory (DRAM). The ROM is, for example, an EEPROM. The storage unit 24 may function as a main storage device, an auxiliary storage device, or a cache memory. The storage unit 24 stores data used for the operation of the terminal device 20 and data acquired through the operation of the terminal device 20.

The control unit 25 includes at least one processor, at least one dedicated circuit, or a combination thereof. The processor is a general-purpose processor such as a CPU or a GPU, or a dedicated processor specialized for a specific process, for example. The dedicated circuit is, for example, an FPGA or an ASIC. The control unit 25 performs processes related to the operation of the terminal device 20 while controlling each unit of the terminal device 20.

The function of the terminal device 20 is realized by executing the control program according to the present embodiment with the processor corresponding to the control unit 25. That is, the function of the terminal device 20 is realized by software. The terminal program causes the computer to perform the operation of the terminal device 20 so that the computer functions as the terminal device 20. That is, the computer functions as the terminal device 20 by performing the operation of the terminal device 20 according to the terminal program.

A part or all the functions of the terminal device 20 may be realized by a dedicated circuit corresponding to the control unit 25. That is, some or all the functions of the terminal device 20 may be realized by hardware.

Process of Terminal Device 20A

Hereinafter, the communication unit 21, the input unit 22, the output unit 23, the storage unit 24, and the control unit 25 included in the terminal device 20A are described as the “communication unit 21A”, the “input unit 22A”, the “output unit 23A”, and the “storage unit 23A”, the “storage unit 24A”, and the “control unit 25A”, respectively.

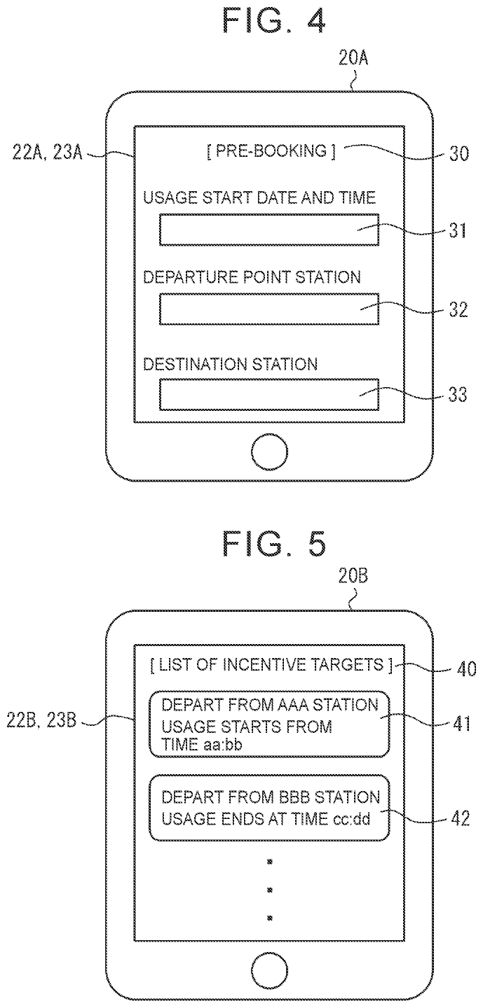

The control unit 25A receives an input instructing an activation of the reservation application by the input unit 22A. When the control unit 25A receives this input by the input unit 22A, the control unit 25A activates the reservation application. After activating the reservation application, the control unit 25A causes the output unit 23A to output a reservation screen 30 as shown in FIG. 4 based on the input of the user 3A received from the input unit 22A. In FIG. 4, the output unit 23A is a display. Further, the input unit 22A is a touch screen provided integrally with the output unit 23A, which is a display. The reservation screen 30 includes an area 31, an area 32, and an area 33. The area 31 is an area for inputting the desired start date and time. The area 32 is an area for inputting the desired departure point. The area 33 is an area for inputting the desired destination.

The control unit 25A receives the desired condition of the user 3A by the input unit 22A. The control unit 25A transmits the desired condition of the user 3A to the information processing device 10 via the network 2 by the communication unit 21A.

After transmitting the desired condition of the user 3A, the control unit 25A receives the establishment notification or the non-establishment notification by the communication unit 21A from the information processing device 10 via the network 2. When the control unit 25A receives the establishment notification, the control unit 25A causes the output unit 23A to output information indicating that the usage reservation of car sharing has been established under the desired condition of the user 3A. When the control unit 25A receives the non-establishment notification, the control unit 25A causes the output unit 23A to output information indicating that the usage reservation of car sharing has not been established under the desired condition of the user 3A.

Process of Terminal Device 20B

Hereinafter, the communication unit 21, the input unit 22, the output unit 23, the storage unit 24, and the control unit 25 included in the terminal device 20B are described as a “communication unit 21B”, an “input unit 22B”, an “output unit 23B”, a “storage unit 24B”, and a “control unit 25B”, respectively.

The control unit 25B receives an input instructing the activation of the reservation application by the input unit 22B. When the control unit 25B receives this input by the input unit 22B, the control unit 25B activates the reservation application. After activating the reservation application, the control unit 25B causes the output unit 23B to output a reservation screen 40 as shown in FIG. 5, based on the input of the user 3B received from the input unit 22B. In FIG. 5, the output unit 23B is a display. Further, the input unit 22B is a touch screen provided integrally with the output unit 23B, which is a display. On the reservation screen 40, the usage conditions to which the incentive is given are displayed as an “incentive target list”. For example, the reservation screen 40 includes an area 41 and an area 42. In the area 41, the usage condition is displayed in which the usage start date and time is “aa:bb” and the departure point is “AAA station”. In the area 42, the usage condition is displayed in which the usage end date and time is “cc:dd” and the destination is “BBB station”. The user 3B looks at such a usage condition output from the output unit 23B, and considers which usage condition to select to make the usage reservation of car sharing.

The control unit 25B can receive an input for selecting the usage condition by the input unit 22B. In FIG. 5, the input for selecting the usage condition is a touch operation of the user 3B on the area where the usage condition such as the areas 41 and 42 are displayed. When the control unit 25B receives the input for selecting the usage condition by the input unit 22B, the control unit 25B generates an application notification based on the input of the user 3B received from the input unit 22B. The application notification is a notification for applying for a usage reservation of car sharing under the selected usage condition. The control unit 25B transmits the application notification to the information processing device 10 via the network 2, by the communication unit 21B.

Operation of Information Processing Device

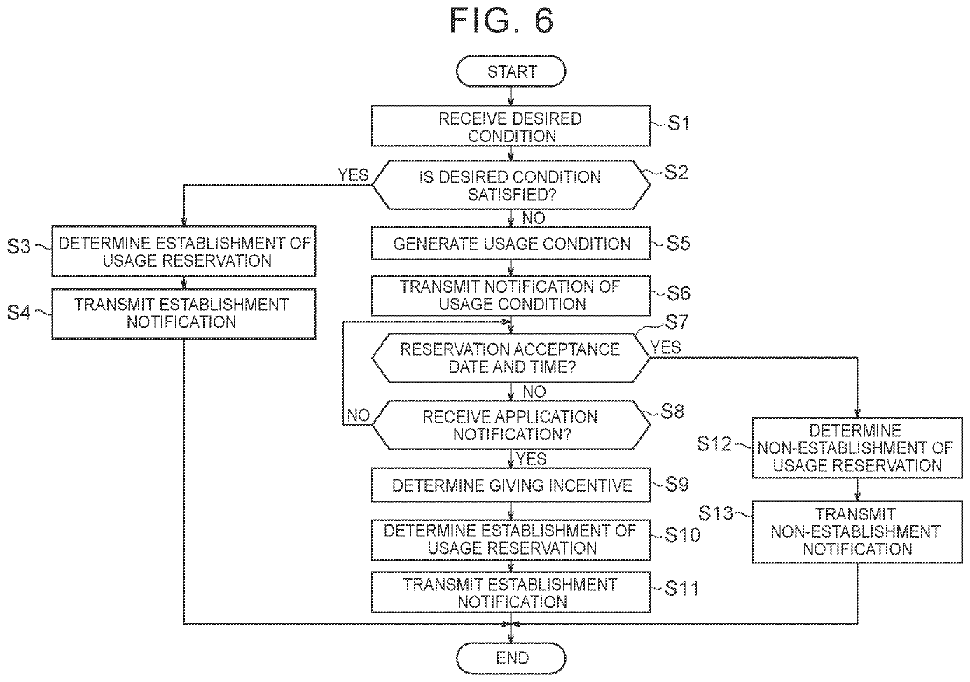

FIG. 6 is a flowchart showing an operation of the information processing device 10 shown in FIG. 2. The operations correspond to an example of the information processing method according to the present embodiment. For example, when the terminal device 20A causes the information processing device 10 to transmit the desired condition of the user 3A, the control unit 13 starts the process of step S1.

The control unit 13 receives the desired condition of the user 3A by the communication unit 11, from the terminal device 20A via the network 2 (step S1). When the current date and time becomes the date and time t0 as shown in FIG. 3, the control unit 13 determines whether the desired condition of the user 3A is satisfied based on the usage reservation status of car sharing (step S2).

When the control unit 13 determines that the desired condition of the user 3A is satisfied (step S2: YES), the control unit 13 proceeds to the process of step S3. On the other hand, when the control unit 13 determines that the desired condition of the user 3A is not satisfied (step S2: NO), the control unit 13 proceeds to the process of step S5.

In the process of step S3, the control unit 13 determines the establishment of the usage reservation of car sharing under the desired condition of the user 3A. In the process of step S4, the control unit 13 transmits the establishment notification by the communication unit 11 to the terminal device 20A via the network 2.

In the process of step S5, the control unit 13 generates the usage condition for the other user of car sharing to satisfy the desired condition of the user 3A.

In the process of step S6, the control unit 13 notifies the other user of the generated desired condition as a condition to which an incentive is given.

In the process of step S7, the control unit 13 determines whether the current date and time is the acceptance start date and time t1 as shown in FIG. 3. When the control unit 13 determines that the current date and time is the acceptance start date and time t1 (step S7: YES), the control unit 13 proceeds to the process of step S12. When the control unit 13 determines that the current date and time is not the acceptance start date and time t1 (step S7: NO), the control unit 13 proceeds to the process of step S8.

In the process of step S8, the control unit 13 determines whether the application notification has been received by the communication unit 11 from the terminal device 20 of the other user via the network 2. When the control unit 13 determines that the application notification has been received (step S8: YES), the control unit 13 proceeds to the process of step S9. When the control unit 13 determines that the application notification is not received (step S8: NO), the control unit 13 executes the process of step S7 again.

In the process of step S9, the control unit 13 determines to give an incentive to the other user who has sent the application notification, that is, the other user who has made a usage reservation of car sharing so as to satisfy the usage condition. The control unit 13 may transmit a notification such as an e-mail notifying the grant of an incentive to the terminal device 20 of the other user via the network 2 by the communication unit 11. By the process of steps S7, 8 and 9, the control unit 13 determines to give an incentive to the other user when the application notification is received from the terminal device 20 of the other user before the acceptance start date and time.

In the process of step S10, the control unit 13 determines the establishment of the usage reservation of car sharing under the desired condition of the user 3A. In the process of step S11, the control unit 13 transmits the establishment notification to the terminal device 20A via the network 2 by the communication unit 11.

In the process of step S12, the control unit 13 determines that the usage reservation of car sharing is not established under the desired condition of the user 3A. When the usage reservation of car sharing is not made so that other user satisfies the usage condition by the acceptance start date and time by the process of steps S7, S8, S12, it is determined that the usage reservation of car sharing is not established under the desired condition of the user 3A.

In the process of step S13, the control unit 13 transmits a non-establishment notification to the terminal device 20A via the network 2 by the communication unit 11.

When the control unit 13 posts the usage condition as a condition for giving an incentive to the site of the car sharing service in the process of step S6, the control unit 13 ends the posting of the usage condition in the process of steps S10 and S12.

In this way, in the information processing device 10, when it is determined that the desired condition of the user 3A is not satisfied, the control unit 13 generates the usage condition of another user of car sharing to satisfy the desired condition of the user 3A. When the other user makes a usage reservation of car sharing so as to satisfy the usage condition, the control unit 13 determines that an incentive is given to the other user. By giving an incentive, it is possible to motivate the other user to make the usage reservation of car sharing so as to satisfy the usage condition. With such a configuration, since the possibility that the desired condition of the user 3A is satisfied is increased, the usage reservation of car sharing is easily established. Thus, according to the present embodiment, it is possible to provide a technique that facilitates the establishment of a usage reservation of car sharing.

Further, in the information processing device 10, the control unit 13 may notify the other user of the generated usage condition as a condition for which an incentive is given. By notifying the other user of the usage condition as a condition for which an incentive is given, it is possible to increase the motivation for the other user to make a usage reservation of car sharing so that the usage condition is satisfied. Thus, it becomes easier to make a usage reservation of car sharing.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the control unit 13 of the information processing device 10 has been described as being able to accept the user's desired condition until the acceptance start date and time t1 as shown in FIG. 3. However, when the control unit 13 executes the determination process at the date and time t0 as shown in FIG. 3, the control unit 13 may be able to accept the user's desired condition until the date and time t0.

For example, in the above-described embodiment, the car sharing service has been described as being a one-way type service. However, the car sharing service is not limited to a one-way type service. As another example, the car sharing service may be a trip type service. The trip type car sharing service requires the vehicle to be returned to the station where the vehicle is rented. In the trip type car sharing service, the usage reservation of car sharing may be a usage reservation for a time frame in which the vehicle is scheduled to be used. In this case, the user's desired condition may include a desired time frame in which the user wishes to use the vehicle. The desired time frame is, for example, a time zone from the desired start date and time to the desired end date and time. In the information processing device 10, the control unit 13 may receive the user's desired time frame from the terminal device 20 via the network 2 by the communication unit 11 as a user's desired condition. The control unit 13 may determine that the user's desired condition is not satisfied when the user's desired time frame is already reserved by the other user based on the status of the usage reservation of car sharing. The control unit 13 may generate a usage condition that the reserved time frame is changed so as to avoid the desired time frame as a usage condition of the other user. The control unit 13 may transmit a notification such as an e-mail indicating the usage condition to the terminal device 20 of the other user via the network 2 by the communication unit 11. In this case, the other user uses the terminal device 20 to shift the reserved time frame to 30 minutes before or after in order to avoid the desired time frame. The control unit 13 may decide to give an incentive to the other user when the reserved time frame is changed so that the other user avoids the desired time frame.

For example, the control unit 13 may receive a plurality of the same desired conditions from different users. In this case, the control unit 13 may accept only the earliest desired condition among the same desired conditions.

Further, an embodiment is also possible in which, for example, a general-purpose computer functions as the information processing device 10 according to the above embodiment. Specifically, a program describing processing contents for realizing each function of the information processing device 10 according to the above embodiment is stored in the memory of the general-purpose computer, and the program is read out and executed by the processor. Therefore, the present disclosure can also be realized as a program that can be executed by the processor or a non-transitory computer-readable medium that stores the program.

What is claimed is:

1. An information processing device comprising:
a communication unit; and
a control unit that receives, with the communication unit, a desired condition desired by a user regarding a usage reservation of car sharing, in addition to the usage reservation of car sharing,
wherein the control unit
generates a usage condition of another user of car sharing to satisfy the desired condition when the control unit determines that the desired condition of the user is not satisfied based on a status of the usage reservation of car sharing before a desired start date and time at which the user desires to start using a vehicle, and
determines that an incentive is given to the other user when the other user makes a usage reservation of car sharing so as to satisfy the usage condition.

2. The information processing device according to claim 1, wherein when the other user makes the usage reservation of car sharing so as to satisfy the usage condition, the control unit determines that the usage reservation of car sharing under the desired condition of the user is established.

3. The information processing device according to claim 1, wherein when the control unit determines that the desired condition of the user is satisfied, the control unit determines that the usage reservation of car sharing under the desired condition of the user is established.

4. The information processing device according to claim 1, wherein the status of the usage reservation of car sharing includes at least one of a status of a usage reservation of a vehicle and a status of a usage reservation of a parking space.

5. The information processing device according to claim 1, wherein when the control unit generates the usage condition, the control unit notifies the other user of the generated usage condition as a condition for which an incentive is given.

6. The information processing device according to claim 5, wherein the control unit notifies the other user of the usage condition by posting the usage condition on a site of a car sharing service.

7. The information processing device according to claim 5, wherein the control unit notifies the other user of the usage condition by transmitting a notification indicating the usage condition to a terminal device of the other user by the communication unit.

8. The information processing device according to claim 1, wherein the other user is a member registered in advance in a car sharing service.

9. The information processing device according to claim 1,
wherein the desired condition includes a desired departure point,
wherein when the control unit determines that there is no vehicle that is able to be rented at the desired departure point at the desired start date and time, the control unit determines that the desired condition of the user is not satisfied, and
wherein the usage condition is a condition in which the desired start date and time is set as a usage end date and time and the desired departure point is set as a destination.

10. The information processing device according to claim 1,
wherein the desired condition includes a desired end date and time and a desired destination,
wherein when the control unit determines that there is no parking space in which a vehicle is able to be parked at the desired destination at the desired end date and time, the control unit determines that the desired condition of the user is not satisfied, and
wherein the usage condition is a condition in which the desired end date and time is set as a usage start date and time and the desired destination is set as a departure point.

11. The information processing device according to claim 1,
wherein the desired condition includes a desired time frame,
wherein when the desired time frame is already reserved by another user, the control unit determines that the desired condition of the user is not satisfied, and
wherein the usage condition is a condition that a reserved time frame is changed so as to avoid the desired time frame.

12. The information processing device according to claim 1, wherein the incentive is a discount on a usage fee of a car sharing service.

13. The information processing device according to claim 1, wherein the incentive is a point that is able to be applied for paying a usage fee of a car sharing service.

14. The information processing device according to claim 1, wherein the control unit is able to accept the desired condition of the user before an acceptance start date and time for starting accepting the usage reservation of car sharing.

15. The information processing device according to claim 14, wherein the control unit determines whether the desired condition of the user is satisfied before a set time amount before the acceptance start date and time.

16. The information processing device according to claim 14, wherein when the control unit receives an application notification of applying for the usage reservation of car sharing under the usage condition by the communication unit from a terminal device of the other user, before the acceptance start date and time, the control unit determines to give an incentive to the other user.

17. The information processing device according to claim 14, wherein when the other user does not make the usage reservation of car sharing so as to satisfy the usage condition by the acceptance start date and time, the control unit determines that the usage reservation of car sharing under the desired condition of the user is not established.

18. The information processing device according to claim 17, wherein when the control unit determines that the usage reservation of car sharing under the desired condition of the user is not established, the control unit transmits a non-establishment notification indicating that the usage reservation of car sharing under the desired condition of the user is not established.

19. An information processing system comprising:
the information processing device according to claim 1; and
a terminal device of the user.

20. An information processing method comprising:
receiving, with a communication unit, a desired condition desired by a user regarding a usage reservation of car sharing, in addition to the usage reservation of car sharing;
generating a usage condition of another user of car sharing to satisfy the desired condition when determining that the desired condition of the user is not satisfied, based on a status of the usage reservation of car sharing, before a desired start date and time at which the user desires to start using a vehicle; and
determining that an incentive is given to the other user when the other user makes a usage reservation of car sharing so as to satisfy the usage condition.
